(19) United States
(12) Patent Application Publication
(10) Pub. No.: US 2011/0307231 A1
(43) Pub. Date: Dec. 15, 2011

(54) METHOD AND ARRANGEMENT FOR CREATING AN INDIVIDUALIZED, COMPUTER-AIDED MODEL OF A SYSTEM, AND A CORRESPONDING COMPUTER PROGRAM AND A CORRESPONDING MACHINE-READABLE STORAGE MEDIUM

(76) Inventors: Jens Kirchner, Erlangen (DE); Albrecht Urbaszek, Heroldsbach (DE)

(21) Appl. No.: 13/084,394

(22) Filed: Apr. 11, 2011

Related U.S. Application Data
(60) Provisional application No. 61/352,836, filed on Jun. 9, 2010.

(51) Int. Cl. G06G 7/60; G06G 7/48

(52) U.S. Cl. 703/11; 703/6

(57) ABSTRACT

A method and an arrangement for creating an individualized, computer-aided model of a system, for determining physiological variables and/or parameters from clinical measurements and continuous measurements. Furthermore, one or more embodiments makes it possible to detect disease-related changes, to the heart in particular, and enables an improved medical interpretation of measurements by implant sensors. The system is not limited to physiological systems, and can also be used to monitor technical systems.

This application claims the benefit of U.S. Provisional Patent Application No. 61/352,836, filed 9 Jun. 2010, the specification of which is hereby incorporated herein by reference.

### BACKGROUND OF THE INVENTION

1. Field of the Invention

Embodiments of the invention relate to a method and an arrangement for creating an individualized, computer-aided model of a system, and a corresponding computer program and a corresponding machine-readable storage medium, which are usable in particular for determining physiological variables and/or parameters from clinical measurements and continuous measurements.

2. Description of the Related Art

Various solutions for evaluating continuously measured data have already been proposed, such as pulse contour analysis using the PiCCO monitor (Pulsion Medical Systems), the continuous determination of cardiac output using the Vigilance monitor (Edwards Lifesciences), and a trend analysis of various parameters derived from IEGM and impedance in the HR predictor (home monitoring function).

Furthermore, a simulation of heart contraction using finite element models e.g., in the Karlsruhe Heart Model (MRI data), or a simulation of blood circulation using a combination of several Windkessel models is known. Cellular models of muscle contraction have likewise already been proposed.

The previous methods for analyzing data delivered by implant sensors such as impedance or blood pressure do not account for individual differences between patients, or do so only to a limited extent. For example, absolute values that are identical for all individuals are used to calculate characteristic quantities for model parameters that are required, and for threshold values at which a certain characteristic quantity indicates pathological changes in the heart. The interpersonal differences can be eliminated to a certain extent by accounting for relative changes to a value that is assumed to be typical for an individual. However, patient-specific information that substantially influences the measurements, in particular the heart geometry, the position of the sensors (e.g. electrodes), dilatability of the arteries, etc., are not taken into account.

Pulse contour analysis is an example of this. The objective of pulse contour analysis is to determine the systolic discharge based solely on the arterial blood pressure signal. Simple methods of doing this exist, but more accurate methods require knowledge of further physiological parameters e.g. the dilatability of the artery. A conventional approach to eliminating this problem is to use values that were determined by averaging a patient collective. The values stated in the literature e.g., for the compliance of the pulmonary artery vary between individual patients by more than a factor of 10, however, and so the diagnostic utility for an individual patient is greatly reduced. According to another approach, the values are calculated using algorithms on the basis of approximations or additional assumptions based on the available measurement signals. For example, a comparison of reconstruction methods yields values for pulmonary arterial compliance that differ by a factor of 3. It is clear that the conventional solutions are faulty or susceptible to error.

On the other hand, methods exist, e.g. from the field of imaging, that provide a great deal of information and thereby make it possible to precisely depict heart contraction, but that can be carried out only once or only at large time intervals since the measurement procedure is elaborate. Thus, they cannot be adapted to the changing physiology over longer periods of time and cannot be used to monitor the patient.

For this reason, special patient-specific simulations were proposed, in particular cardiac activity (using finite element models) and/or the flow behavior of blood in the ventricles of the heart or the blood vessels. One of the most comprehensive approaches in this regard is the Karlsruhe heart model. Models of this type typically obtain their data material from imaging methods and hold the promise of being able to predict e.g. the success of an ablation for different loci in the case of atrial fibrillation. Since the data acquisition is very complex, these methods are limited to depicting the current state of the heart.

### BRIEF SUMMARY OF THE INVENTION

A feature of the present system, therefore, is to provide a method and an arrangement for creating an individualized, computer-aided model of a system, and a corresponding computer program and a corresponding machine-readable storage medium, which prevent the disadvantages of the known solutions and, in particular, yield an improved diagnosis.

This feature is provided, according to one or more embodiments of the invention, by the features claimed herein. Advantageous embodiments of the invention are contained in the dependent claims.

The invention makes it possible to detect disease-related changes, to the heart in particular, and enables an improved medical interpretation of measurements by implant sensors. One or more embodiments of the invention are not limited to physiological systems, and can also be used to monitor technical systems.

A particular advantage of the method according to one or more embodiments of the invention is that preferably patient-specific parameters resulting from individual and possibly pathologically changed anatomical conditions and functional conditions are determined individually and are entered in a model that is used to calculate a therapy-relevant physiological quantity, e.g. cardiac output, from a measurement signal such as pulmonary-arterial blood pressure. Without the individual parameters, it would only be possible to perform a rough and relatively inexact estimate. The individual parameters are preferably determined using suitable, clinically practicable calibration methods. Algorithms for determining physiological parameters that are adapted to the unique conditions of the patient cannot be realized without knowledge of these patient-specific parameters.

In the method according to one or more embodiments of the invention for creating an individualized, computer-aided model of a system it is therefore provided that an initial computer-aided model of the system is created and/or adapted. To create the initial model, data are preferably used that are obtained from a comprehensive, detailed measurement of the system. Since detailed measurements of this type are customarily highly complex, it is provided according to one or more embodiments of the invention that data for a detailed measurement are collected only once or at greater time intervals, preferably at intervals of several months or years. The detailed measurement methods can be e.g. imaging methods such as magnetic resonance imaging (MRI) or computerized tomography (CT) measurements. The data that are used to create the initial model can be acquired e.g. during the implantation of a device used to perform the continuous and/or partially continuous detection of the parameters. The expression “continuous and/or partially continuous detection” relates to continuous measurements and to measurements that are carried out at predeterminable and/or adjustable intervals for a predeterminable and/or adjustable period of time. Preferably, the model is stored, analyzed, and adapted at a central point at which the data from the sensor systems of the implant are likewise input. As an alternative or parallel thereto, the implant can also perform a portion of the storage, analysis, and adaptation.

Once the initial model is created, measured variables or, generally, parameters of the system are still detected continuously or at short time intervals. In a preferred embodiment, the signals are recorded daily for the entire 24 hours or for a suitable shorter period of e.g. 30 minutes. The continuously detected quantities or parameters in general are evaluated and preferably compared to reference values. According to a preferred embodiment, characteristic quantities such as systolic discharge, the probability of tissue having reduced contractility, or sites of necrotic tissue are determined, and the characteristic quantities are compared to reference values. The initial model is adapted depending on the result of the comparison, thereby resulting in the individualized, computer-aided model of the system, or a computer-aided model that has already been individualized is adapted.

According to a preferred embodiment of the method according to one or more embodiments of the invention, the model is a dynamic model. For this purpose, a geometric model can be combined with an algorithm that describes the (time-based) system behavior, for example. According to a preferred embodiment, the model models a physiological system, that is, in particular, anatomical characteristics and/or functional characteristics are modeled, and the algorithm is used to determine physiological parameters by simulating the real system, and therefore the simulation provides physiological variables and/or parameters as the starting quantities. In the case of physiological models, it is preferably provided that sensors are designed as implant sensors in order to continuously acquire the measurement data.

According to one possible embodiment of the present invention, cardiac activity is modeled on the basis of a single clinical measurement or a plurality of data acquisitions performed at large time intervals, and the model is adapted continuously using sensor data from an implant. The thusly adapted model is used to determine diagnostically relevant parameters that indicate the development or worsening of cardiac diseases.

The model can be e.g. a model of parts, at least, of the cardiovascular system, such as the myocardial geometry, a model of a vascular system, in particular a model of branchings, a model of the viscosity and flow profile of the blood, a model of the localized position of sensors for the continuous acquisition of measurement data, or the like.

The model can be used to simulate e.g. cardiac activity such as myocardial contractions, the dilatability of vessels, the flow behavior of fluids (in the vessels), intracellular processes, or the like.

According to a preferred embodiment, the model is realized as a finite element model.

According to a preferred embodiment, the initial model is adapted, in particular optimized, by comparing subsequently continuously measured variables or parameters in general, or characteristic quantities derived from the measured variables or parameters in general with variables or parameters in general, or characteristic quantities that were obtained from the model e.g. by simulation. Depending on the result of the comparison, which can be a similarity value, for example, parameters of the model are varied, and so the model is adapted to the current conditions. The measured variables or parameters in general can be e.g. blood pressure or impedance, and/or the characteristic quantity can be the systolic discharge. According to a preferred embodiment, free parameters are fitted to the measured quantities or parameters in general, or to the characteristic quantities determined from the signals or general parameters.

It has proven particularly advantageous to use the updated individualized model for diagnostic purposes. To this end, it is provided in a preferred embodiment that the updated parameters are supplied to a classificator.

An arrangement according to the invention includes at least one chip and/or processor, and is designed such that a method for creating an individualized, computer-aided model of a system can be carried out, wherein an initial computer-aided model of the system is created, subsequently continuously measured data are evaluated, and the individualized, computer-aided model is created or adapted by modifying the initial model depending on the measured data that are acquired.

A computer program for modeling, once it has been loaded in the memory of a data processing device, enables the data processing device to implement a method for creating an individualized, computer-aided model of a system, wherein an initial computer-aided model of the system is created, subsequently continuously measured data are evaluated, and the individualized, computer-aided model is created by modifying the initial model depending on the measured data that were acquired, or a computer-aided model that has already been individualized is adapted.

According to a further preferred embodiment of the invention, the computer program according to the invention is modular, wherein individual modules are installed on various data processing devices.

According to advantageous embodiments, additional computer programs are provided that can implement further method steps or method sequences that are mentioned in the description.

Computer programs of this type can be provided for downloading (for a fee or free of charge, or in a freely accessible or password-protected manner) in a data network or communication network. The computer programs provided in this manner can then be made usable via a method in which a computer program according the claims is downloaded from an electronic data network such as the Internet onto a data processing device that is connected to the data network.

To implement the method according to one or more embodiments of the invention, a machine-readable storage medium is used, on which a program is stored that, once it has been loaded in the memory of a data processing device, enables the data processing device to implement a method for creating an individualized, computer-aided model of a system, wherein an initial computer-aided model of the system is created, subsequently continuously measured data are evaluated, and the individualized, computer-aided model is created by modifying the initial model depending on the measured data that were acquired, or a computer-aided model that has already been individualized is adapted.

One or more embodiments of the invention provide a computer model for determining physiological variables and parameters from clinical and continuous measurements. In so doing, the advantages of two methods for diagnosing and predicting cardiac disease can be combined: a single, detailed detection of the heart geometry and the contraction behavior e.g., from MRI or CT measurements, with continuous recording of simple measured variables such as impedance and blood pressure in order to continuously monitor the patient. Using the latter data, a model of heart contraction over time that is created once using complex data acquisition is adapted to a changing physiology. At the same time, such a model according to the invention permits a detailed interpretation of sensor data to be performed on a patient-specific information basis, thereby improving the predictors used thus far and enabling the development of new predictors.

In particular, one or more embodiments of the invention result in an improvement in the detection of disease-related changes to the heart and an associated deterioration of its functional capacity. Furthermore, the invention can be used to advantage to predict arrhythmias. Moreover, an improvement in the medical interpretation of measurements by implant sensors on a patient-specific information basis is attained, which results in a more exact diagnosis in particular and can support the planning of medical procedures. Due to the invention, more information about the patient is made available, thereby enabling predictors to function more specifically and, therefore, more accurately. A model that is created according to the invention is an additional feature of home monitoring for the treating physician, and provides information that can be used to make a decision regarding therapy. For example, a warning signal can be transmitted to the physician, and/or instructions can be transmitted to patients via a patient device and/or an external device e.g. information regarding taking a dosage of medication and/or contacting the physician and/or other behavioral instructions. It is likewise possible to depict the derived parameters and/or the derived diagnosis and/or the derived suggestions for therapy and/or the disease and/or medication monitoring in the program, HMSC, and/or an external device.

### BRIEF DESCRIPTION OF THE DRAWINGS

FIG. 1 shows a flow chart to illustrate how diagnostically relevant characteristic numbers are derived;

FIG. 2 shows a scheme for adapting the model parameters to changes in the measured signal.

### DETAILED DESCRIPTION OF THE INVENTION

One or more embodiments of the invention are explained in the following in greater detail with reference to an embodiment.

One or more embodiments of the invention will be explained as follows using a model of cardiological processes as an example. An exemplary algorithm for calculating physiological quantities is supplied by two data sources: permanently incoming sensor data (e.g. within the scope of home monitoring) and data acquisition that is comprehensive and is carried out once (e.g. during implantation) or at large intervals during follow-ups. The characteristic quantities determined in this manner then make it possible to monitor the patient with high reliability.

In an exemplary embodiment of the invention, a patient-specific model is created using a single measurement (or a plurality of longer time intervals), and is adapted over time using measured data obtained by the implant sensor system. A system of this type can be realized in different degrees of complexity and with different objectives: Other elements can be implemented in the algorithm for calculating the systolic discharge of the heart for compliance purposes, such as the viscosity and flow profile of the blood or branchings, which result in pulse wave reflections. In addition to the pulmonary artery, further components of the vascular system can be simulated, as is the case occasionally, if not adaptively and patient-specifically, in multiple-compartment models. In the same manner in which the components of the cardiovascular system can be varied and that can be detected using a model of this type, the latter can also cover different scale ranges and extend to intracellular processes.

An individual, adaptive system of this type combines the advantages of a non-recurring, comprehensive measurement with those of a continuous measurement of a single measured variable. Methods that were previously limited to the information contained in a single measurement signal can now access a much larger and, in particular, individual data pool, thereby resulting in a marked improvement of its accuracy and, therefore, detection and prediction capability. Changes in the shape, amplitude, and offset of the sensor data can be better assigned to certain physiological mechanisms, thereby enabling the early detection of a changed heart geometry that may be pathological. Final, simulations of the system behavior could be carried out after a medical procedure, thereby enabling risks and chances for recovery to be estimated.

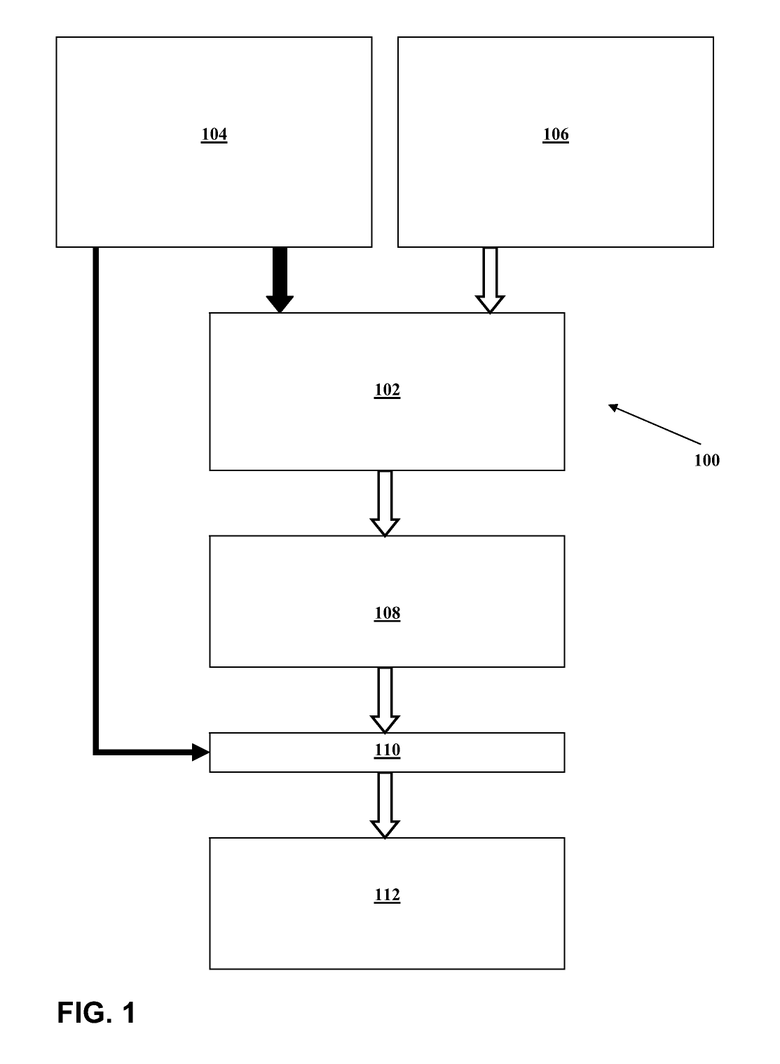

Process 100 of deriving diagnostic characteristic numbers is explained as an example with reference to FIG. 1. Black, solid arrows indicate a non-recurring data flow (or a data flow that occurs at large time intervals), while white arrows outlined in black indicate processes that are continuous or that occur at short, regular intervals. An initial model of the cardiovascular system is created on the basis of an extensive quantity of data that describe a cardiovascular system in detail (step 102). According to a preferred embodiment, a time-adaptive, complex model of the cardiovascular system is created. A time-adaptive, complex model of this type can include e.g. a pulse contour analysis, a simulation of the propagation of electrical impulses, a simulation of blood flow, and/or a simulation of contraction.

This initial model of the cardiovascular system is based on non-recurring acquisition 104 of data that describe the system in detail. These data can be e.g.
the geometry of the myocardium,
the fiber direction of the myocardium,
the propagation of electrical impulses on the myocardium,
the position of electrodes of an implant,
the geometry of the arterial vascular system, and/or
the compliance of the arterial vessels.

Non-recurring acquisition 104 of data is carried out using e.g. imaging methods such as MRI measurements or CT measurements.

To adapt the initial model of the cardiovascular system, a continuous measurement 106 is performed of quantities or, in general, parameters of the cardiovascular system e.g. impedance or blood pressure, and/or an intracardiac electrogram (IEGM) is performed.

Characteristic numbers are derived (step 108) from the data obtained in continuous measurement 106. As the characteristic number, for example, the systolic discharge can be derived from the arterial blood pressure. Further characteristic numbers can be e.g. the probability of tissue having reduced contactility, or sites of necrotic tissue (related details are provided below).

The characteristic number(s) is/are compared with reference values in step 110. These reference values can have been determined in entirety or partially during initial measurement 104 e.g. by performing measurements under defined physiological conditions (e.g. at rest/under stress, with intrinsic/stimulated rhythm, or during administration of medication). System states are signaled in step 112 depending on the result of the comparison. This can take place e.g. in the form of a display in a remote monitoring system such as the Home Monitoring Service Center (HMSC), a display in an external medical device, or the like. As an alternative or in addition thereto, implant settings can be (automatically) changed, or recommendations can be sent to a physician depending on the result of the comparison.

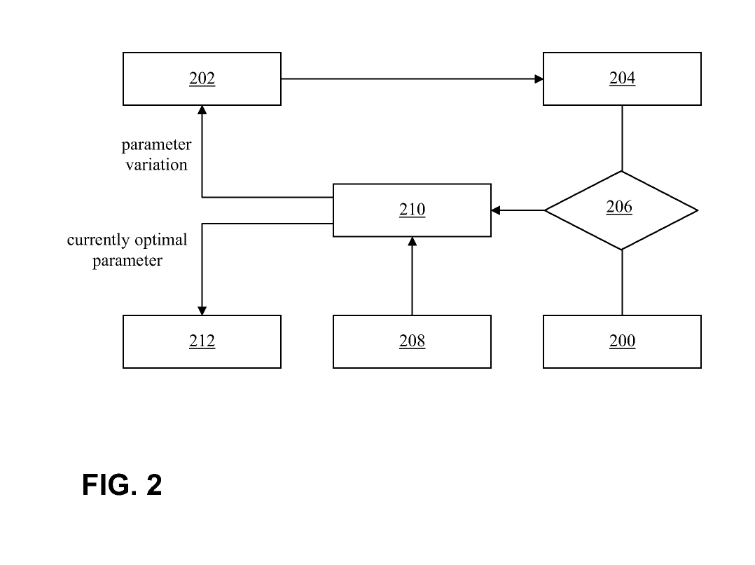

The adaptation of model parameters to changes in measured signals is illustrated in FIG. 2. To adapt, in particular optimize, the parameters, (continuously) measured signals 200 are compared to corresponding signals 204 simulated using model 202, and a measure 206 of the agreement between measured signal 200 and signal 204 obtained via simulation is determined. Model 202 can be e.g. a model of the contraction of the myocardium and the blood flow. In this case, measured signals 200 and simulated signals 204 could be evaluated e.g. as blood pressure and intracardial impedance; measure 206 of the agreement can be determined by integrating the curve difference over one cycle, for example. For the parameter variation, certain requirements 208 are set for parameters, although they can be varied, e.g. loci of potentially undersupplied tissue in the case of model 202 of the contraction behavior. Depending on measure 206 of agreement and requirements 208 for the parameter variation, the parameters of model 202 undergo an optimization 210. The current optimal parameters are supplied to an evaluation unit, e.g. a classificator 212, for diagnostic purposes. In the special case of model 202 of the contraction behavior, a finding could be determined as to whether a minor, moderate, or high risk of cardiac insufficiency is present.

Model 202 is adapted by performing a regular or even continuous comparison with sensor data 200, such as impedance or blood pressure, which are recorded by an implant and are transmitted for further evaluation within the scope of home monitoring. By optimizing the simulation on the basis of the measured data, a change in the heart geometry or conduction can be identified, its continued development can be interpolated, and potential complications can be predicted at an early stage.

It is likewise possible to monitor medication. For patients with diuresis, an increased/reduced blood volume will be exhibited in the blood pressure in particular. Furthermore, medications that intervene in the ionic balance of the cells can be coupled into the system using a cellular model.

Depending on which model 202 is used, different forms of parameter optimization are possible, such as:
Parameter-estimating methods
Trial-and-error methods
In this case, a test is carried out to determine whether a change in the course of the signal can be “explained” by one or more elements of a predefined set of potential diseases. In a model 202 that simulates contraction behavior and blood flow, it is possible to predefine e.g. a plurality of myocardial regions where contractility decreases when blood supply is reduced. In parameter optimization 210, a test is conducted to determine whether a reduction in the contractility in steps of e.g. 25% in one of the regions or a combination thereof can simulate blood pressure and intracardial impedance signals 200 that were measured.

Due to the complexity of model 202, the data are preferably not processed in the implant that delivers continuous data 200, but rather in an external device. Two possibilities for this are provided in parallel or as alternatives:
1. Service Center Data 200 are transmitted to an external center for further processing
2. External Device e.g. stationary patient monitoring; support for implant programming.

Depending on the embodiment of the system for data processing, the following possibilities are provided in parallel or as alternatives as the interface to the physician or the patient:
1.1 Display characteristic numbers or trends in the HMSC,
1.2 Output warning signals if a threshold value is exceeded (in the HMSC, per SMS to the treating physician),
2.1 Display characteristic numbers in an external device,
2.2 Suggest parameter settings for an implant in an external device.

The mode of operation of the invention is described below in greater detail:

### Calculation of Systolic Discharge

Instead of methods that rely exclusively on arterial blood pressure to calculate the systolic discharge, in the case of a non-recurring measurement 104 that is carried out e.g. during the implantation of the pressure sensor, important quantities of the affected vascular system are measured, such as the impedance spectrum or compliance. Using model 202 for the determination of systolic discharge, which can be realized as a result, oscillatory components of the blood flow can be detected, for example.

Further diagnostic possibilities are obtained by combining a vascular model with a measurement of blood pressure: The pulse wave speeds can be estimated using the vascular model by detecting reflected pressure waves in the signal, and based on the knowledge of the reflection points or the distances traveled.

### Intracardial Impedance Measurements

Signal 200 can be better interpreted by integrating an intracardial impedance measurement in a blood flow model or contraction model 202, as described below, and based on the knowledge of the position of the electrodes. For example, the impedance value could be used to deduce changes relative to the current-carrying volume object, and it could be associated with and/or related to the total ventricular capacity.

### Detection of Tissue Changes

Measurements of IEGM, intracardial impedance, and blood pressure are the result of conduction or contraction of the myocardium, and therefore are a type of projection of these more complex signal developments onto simple measured variables. Proceeding from a model 202, which combines e.g. myocardial geometry and conduction with the resultant IEMG, long-term changes in the IEGM can be traced back to changes in the conductive tissue. The same applies for changes in the contraction behavior of the myocardium, which could be discovered by measuring impedance and/or blood pressure.

For example, as shown in FIG. 2, a change in measured signal 200 is traced back to a change in complex physiological model 202 by varying the parameters that describe the vascular properties or contraction properties. The optimization algorithm determines the new parameters when simulated signal 204, that is, signal 204 derived from the model and measured signal 200 agree to the greatest extent possible.

Compared to the previous methods e.g. for detecting losses of contractility based solely on the stated measured variables, a plurality of advantages result:
High sensitivity and specificity of the methods used since error detections and events that are not detected or that are detected too late due to a patient's unique condition can be prevented by coupling into the physiology to a greater extent.
Further sensor variables can be added to a more complex model of this type.
Since changes in continuously measured signals 200 can be traced back to the physiology, the health status and chances of success of special therapeutic options can be assessed.

It will be apparent to those skilled in the art that numerous modifications and variations of the described examples and embodiments are possible in light of the above teaching. The disclosed examples and embodiments are presented for purposes of illustration only. Other alternate embodiments may include some or all of the features disclosed herein. Therefore, it is the intent to cover all such modifications and alternate embodiments as may come within the true scope of this invention.

### REFERENCE NUMERALS

100 Process of deriving diagnostic characteristic numbers
102 Create the model
104 Non-recurring acquisition of data
106 Continuous measurement of parameters
108 Derive characteristic numbers
110 Compare with reference values
112 Signal system states
200 Measured signal
202 Model
204 Simulated signal
206 Measure of agreement
208 Requirements for the parameter variation
210 Parameter optimization
212 Classificator

What is claimed is:

1. A method for creating an individualized, computer-aided model of a system, comprising:
creating an initial computer-aided model of the system;
detecting measured data that are subsequently continuously and/or intermittently continuously;
evaluating said measured data;
creating or adapting an individualized computer-aided model by modifying the initial computer-aided model of the system depending on the measured data detected.

2. The method according to claim 1, wherein creating or adapting the individualized computer-aided model comprises utilizing an algorithm that simulates behavior of said system.

3. The method according to claim 1, further comprising using the individualized computer-aided model to model a physiological system.

4. The method according to claim 3, further comprising using the individualized computer-aided model to model a cardiovascular system or a vascular system or parts thereof.

5. The method according to claim 4, further comprising obtaining subsequently acquired measured data using by implant sensors.

6. The method according to claim 1, further comprising modifying the initial computer-aided model by comparing at least a portion of subsequently acquired measured data or data obtained from the subsequently acquired measured data with values obtained in the simulation, and varying parameters of the initial computer-aided model depending on the result of said comparing.

7. The method according to claim 6, wherein the initial model is modified by fitting free parameters to the subsequently acquired measured data or to the data obtained from the subsequently acquired measured data.

8. The method according to claim 6, further comprising using parameter-estimating methods and/or trial-and-error methods to modify the initial model.

9. The method according to claim 1, further comprising creating the initial model by evaluating data that are obtained by performing a detailed measurement of the system.

10. The method according to claim 9, wherein said performing said detailed measurement includes imaging with x-ray, sonography, scanning, PET, magnetic resonance imaging, and/or computerized tomography.

11. The method according to claim 1, further comprising using said individualized computer-aided model for diagnostic purposes.

12. An apparatus comprising at least one chip and/or processor configured to:
create an initial computer-aided model of a system;
detect measured data that are subsequently continuously and/or intermittently continuously;
evaluate said measured data;
create or adapt an individualized computer-aided model by modifying the initial computer-aided model of the system based on the measured data detected.

13. The apparatus of claim 12 further comprising
a storage element;
a computer program that, once it has been loaded into storage element of said at least one chip and/or processor is configured to perform said create, said detect, said evaluate and said create or adapt.
